(19) United States
(12) Patent Application Publication
(10) Pub. No.: US 2015/0148981 A1
(43) Pub. Date: May 28, 2015

(54) SYSTEM AND METHOD FOR MULTI-CORRELATIVE LEARNING THERMAL MANAGEMENT OF A SYSTEM ON A CHIP IN A PORTABLE COMPUTING DEVICE

(71) Applicant: Qualcomm Incorporated, San Diego, CA (US)

(72) Inventors: FAN PENG KONG, Richmond Hill (CA); DARIUSZ KROLIKOWSKI, Mississauga (CA); WILSON HUNG YU, Markham (CA); SHIJU MATHEW, Scarborough (CA); SIDDHARTH ZAVERI, Scarborough (CA)

(73) Assignee: Qualcomm Incorporated, San Diego, CA (US)

(21) Appl. No.: 14/088,434

(22) Filed: Nov. 24, 2013

(51) Int. Cl. G05D 23/19

(52) U.S. Cl. CPC G05D 23/1927; G05D 23/1917
USPC 700/299

(57) ABSTRACT

Various embodiments of methods and systems for multi-correlative learning thermal management (“MLTM”) techniques implemented in a portable computing device (“PCD”) are disclosed. Notably, in many PCDs, thermal energy levels measured by individual temperature sensors in the PCD may be attributable to a plurality of processing components, i.e. thermal aggressors. Generally, as more power is consumed by the thermal aggressors, the resulting generation of thermal energy may cause the temperature thresholds associated with temperature sensors located around the chip to be exceeded, thereby necessitating that the performance of the PCD be sacrificed in an effort to reduce thermal energy generation. Advantageously, embodiments of MLTM systems and methods recognize that multiple thermal aggressors affect temperature readings of individual temperature sensors differently and seek to identify and apply optimum performance level settings combinations that optimize quality of service (“QoS”) while maintaining thermal energy levels at the sensors within predetermined temperature thresholds.

### DESCRIPTION OF THE RELATED ART

Portable computing devices (“PCDs”) are becoming necessities for people on personal and professional levels. These devices may include cellular telephones, portable digital assistants (“PDAs”), portable game consoles, palmtop computers, and other portable electronic devices.

One unique aspect of PCDs is that they typically do not have active cooling devices, like fans, which are often found in larger computing devices such as laptop and desktop computers. Instead of using fans, PCDs may rely on the spatial arrangement of electronic packaging so that two or more active and heat producing components are not positioned proximally to one another. Many PCDs may also rely on passive cooling devices, such as heat sinks, to manage thermal energy among the electronic components which collectively form a respective PCD.

The reality is that PCDs are typically limited in size and, therefore, room for components within a PCD often comes at a premium. As such, there usually isn't enough space within a PCD for engineers and designers to mitigate thermal degradation or failure of processing components by using clever spatial arrangements or strategic placement of passive cooling components. Therefore, current systems and methods rely on various temperature sensors embedded on the PCD chip to monitor the dissipation of thermal energy. Because the temperature sensors are mapped to individual processing components, their measurements may be used to trigger application of thermal management techniques for those processing components.

Current systems and methods, however, often fail to consider the thermal relationship between multiple thermal aggressors (such as processors) and multiple temperature sensors. As such, in response to temperature readings, current systems and methods may not optimally adjust settings of all thermally aggressive components in a PCD in view of a target temperature. Therefore, what is needed in the art is a system and method for multi-correlative learning thermal management in a PCD. More specifically, what is needed in the art is a system and method that learns the thermal characteristics of a PCD and then, based on the thermal response to settings adjustments of thermal aggressors, updates the thermal characteristic to improve future thermal energy management. Further, what is needed in the art is a system and method that, based on the thermal response to settings adjustments of thermal aggressors, estimates ambient temperature and compensates the thermal characteristic of the PCD to improve thermal energy management.

### SUMMARY OF THE DISCLOSURE

Various embodiments of methods and systems for multi-correlative learning thermal management (“MLTM”) techniques implemented in a portable computing device (“PCD”) are disclosed. Notably, in many PCDs, thermal energy levels measured by individual temperature sensors in the PCD may be attributable to a plurality of processing components, i.e. thermal aggressors. Generally, as more power is consumed by the various processing components, the resulting generation of thermal energy may cause the temperature thresholds associated with temperature sensors located around the chip to be exceeded, thereby necessitating that the performance of the PCD be sacrificed in an effort to reduce thermal energy generation. Advantageously, embodiments of MLTM systems and methods recognize that multiple thermal aggressors affect temperature readings of individual temperature sensors and seek to identify and apply optimum performance level settings combinations that optimize QoS while maintaining thermal energy levels within predetermined temperature thresholds.

An exemplary embodiment of an MLTM method defines a discrete number of performance levels for each of a plurality of processing components in a PCD. As one of ordinary skill in the art would recognize, each of the performance levels, or bin settings, is associated with a power frequency supplied to the one or more processing components. Next, target temperature thresholds associated with each of a plurality of temperature sensors located around a chip may be defined. The temperature sensors are monitored for an interrupt signal that indicates an alert that a target temperature threshold has been exceeded.

If the target temperature has been exceeded before, and a performance level combination successfully applied to the processing components to clear the alert, then the previously learned performance level combination may be applied. If no optimum performance level combinations have been previously learned in connection with the target temperature that has been exceeded, then the performance level for each of the plurality of processing components may be set to a minimum performance level. Subsequently, temperature signals from the temperature sensor may be sampled at time based intervals to generate a heat dissipation curve associated with the first temperature sensor. Once a stabilized temperature signal from the temperature sensor is recognized, the stabilized temperature may be associated with an ambient environment temperature. Notably, as one of ordinary skill in the art would recognize, the ambient environment temperature to which the PCD is exposed may affect the rate of thermal energy dissipation from the PCD.

Next, the performance levels of each of the plurality of processing components (i.e., the bin settings or supplied power levels) may be systematically incremented to learn performance level combinations for the plurality of processing components that generate thermal energy levels within the target temperature threshold for the temperature sensor. All valid combinations of performance levels identified for the processing components may be stored in a thermal settings database as learned performance level combinations in association with the temperature sensor, the ambient environment temperature, the target temperature and the heat dissipation curve. From the valid combinations of performance levels, an optimum performance level combination may be selected and applied to the plurality of processing components, thus driving the thermal energy levels to within the target temperature while optimizing QoS. The optimum performance level combination may be stored in a dynamic mitigation table so that it can be quickly identified and applied in the event that the sensor recognizes a thermal event that causes the target temperature to be exceeded again. Notably, the optimum performance level combination may be selected from the valid combinations based on the active aggressors' bin settings at the time of the thermal event. In this way, the optimum bin settings may be selected based on their multi-correlation with the bin settings of active thermal aggressors together with the resulting temperature's relative closeness to the target temperature.

Future applications of the optimum performance level combination stored in the dynamic mitigation table may be monitored to identify an increase or decrease in the ambient environment temperature. That is, if the temperature reading of the sensor is higher after a certain duration than it was when the optimum performance level combination was last applied, the method may conclude that the ambient environment temperature has risen and, accordingly, adjust the optimum performance level combinations stored in the dynamic mitigation table such that combinations previously associated with lower target temperatures are associated with higher target temperatures moving forward. Similarly, if the temperature reading of the sensor is lower after a certain duration than it was when last applied, or the target temperature is reached more quickly than expected, the method may conclude that the ambient environment temperature has decreased and, accordingly, adjust the optimum performance level combinations stored in the dynamic mitigation table such that combinations previously associated with higher target temperatures are associated with lower target temperatures moving forward.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is an illustration of exemplary thermal dynamics between multiple thermal aggressors and multiple temperature sensors in a system on a chip (“SOC”);

FIG. 2 is a functional block diagram illustrating an embodiment of an on-chip system for implementing multi-correlative learning thermal management methodologies in a portable computing device (“PCD”);

FIG. 3 is a functional block diagram illustrating an exemplary, non-limiting aspect of the PCD of FIG. 2 in the form of a wireless telephone for implementing methods and systems for multi-correlative learning thermal management of multiple processing components through learned optimal settings associated with target temperatures of multiple thermal sensors;

FIG. 4A is a functional block diagram illustrating an exemplary spatial arrangement of hardware for the chip illustrated in FIG. 3;

FIG. 4B is a schematic diagram illustrating an exemplary software architecture of the PCD of FIG. 3 for multi-correlative learning thermal management;

FIGS. 5A-5C are a logical flowchart illustrating a method for managing thermal energy generation in the PCD of FIG. 2 through multi-correlative learning of the thermal dynamics between multiple thermal aggressors and multiple temperature sensors;

FIG. 6 is a logical flowchart illustrating a sub-method or subroutine for an initial full iterative learning of the multi-correlative thermal dynamics between multiple thermal aggressors and multiple temperature sensors in association with a given target temperature; and

FIG. 7 is a logical flowchart illustrating a sub-method or subroutine for an additional incremental iterative learning of the multi-correlative thermal dynamics between multiple thermal aggressors and multiple temperature sensors in association with a given target temperature.

### DETAILED DESCRIPTION

The word “exemplary” is used herein to mean “serving as an example, instance, or illustration.” Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein may also include files that are not executable in nature, such as documents that may need to be opened or other data files that need to be accessed.

As used in this description, the terms “component,” “database,” “module,” “system,” “thermal energy generating component,” “processing component,” “thermal aggressor” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” “graphical processing unit (“GPU”),” and “chip” are used interchangeably. Moreover, a CPU, DSP, GPU or a chip may be comprised of one or more distinct processing components generally referred to herein as “core(s).”Additionally, to the extent that a CPU, DSP, GPU, chip or core is a functional component within a PCD that consumes various levels of power to operate at various levels of functional efficiency, one of ordinary skill in the art will recognize that the use of these terms does not limit the application of the disclosed embodiments, or their equivalents, to the context of processing components within a PCD. That is, although many of the embodiments are described in the context of a processing component, it is envisioned that multi-correlative learning thermal management policies may be applied to any functional component within a PCD including, but not limited to, a modem, a camera, a wireless network interface controller (“WNIC”), a display, a video encoder, a peripheral device, a battery, etc.

Further to that which is defined above, a “processing component” or “thermal energy generating component” or “thermal aggressor” may be, but is not limited to, a central processing unit, a graphical processing unit, a core, a main core, a sub-core, a processing area, a hardware engine, etc. or any component residing within, or external to, an integrated circuit within a portable computing device. Moreover, to the extent that the terms “thermal load,” “thermal distribution,” “thermal signature,” “thermal footprint,” “thermal dynamics,” “thermal processing load” and the like are indicative of workload burdens that may be running on a processor, one of ordinary skill in the art will acknowledge that use of these “thermal” terms in the present disclosure may be related to process load distributions, workload burdens and power consumption.

In this description, it will be understood that the terms “thermal” and “thermal energy” may be used in association with a device or component capable of generating or dissipating energy that can be measured in units of “temperature.” Moreover, it will be understood that the terms “thermal footprint,” “thermal dynamics” and the like may be used within the context of the thermal relationship between two or more components within a PCD and may be quantifiable in units of temperature. Consequently, it will further be understood that the term “temperature,” with reference to some standard value, envisions any measurement that may be indicative of the relative warmth, or absence of heat, of a “thermal energy” generating device or the thermal relationship between components. For example, the “temperature” of two components is the same when the two components are in “thermal” equilibrium.

In this description, the terms “thermal mitigation technique(s),” “thermal policies,” “thermal management,” “thermal mitigation measure(s),” “throttling to a performance level” and the like are used interchangeably. Notably, one of ordinary skill in the art will recognize that, depending on the particular context of use, any of the terms listed in this paragraph may serve to describe hardware and/or software operable to increase performance at the expense of thermal energy generation, decrease thermal energy generation at the expense of performance, or alternate between such goals.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop computer with a wireless connection, among others.

In this description, the terms “performance setting,” “bin setting,” “power level” and the like are used interchangeably to reference the power level supplied to a thermally aggressive processing device.

Managing thermal energy generation in a PCD, without unnecessarily impacting quality of service (“QoS”), may be accomplished by leveraging one or more sensor measurements that each indicate thermal energy generated by, and dissipated from, one or more thermal aggressors. By closely monitoring the temperatures of thermal sensors located strategically around a chip, a multi-correlative learning thermal manager (“MLTM”) module in a PCD may systematically identify optimum combinations of performance levels for a group of thermally aggressive processing components that collectively contribute to the temperatures measured by the thermal sensors.

For a given target temperature of a thermal sensor, the MLTM module may cause the power levels supplied to the thermal aggressors to be incremented up and down systematically, one device and one bin at a time, in an effort to find valid combinations of bin settings that will prevent thermal energy generation in excess of the target temperature. In doing so, the MLTM may also deduce the temperature of the ambient environment to which the PCD is exposed. Advantageously, with knowledge of the ambient temperature and the target operating temperature, the learned combinations of bin settings may be applied in future use cases so that the target temperature is maintained through a balance of thermal energy generation across all the thermal aggressors. Additionally, and as one of ordinary skill in the art will recognize, because multi-correlative learning thermal management methods may be applied without regard for the specific mechanics of thermal energy dissipation in a given PCD under a given workload, engineers and designers may employ a multi-correlative learning thermal management approach without consideration of a PCD's particular form factor.

Notably, although exemplary embodiments of multi-correlative learning thermal management methods are described herein in the context of a central processing unit (“CPU”) and a graphical processing unit (“GPU”), application of multi-correlative learning thermal management methodologies are not limited to a CPU and/or GPU combination of thermal aggressors. It is envisioned that embodiments of multi-correlative learning thermal management methods may be extended to any combination of thermal aggressors and thermal sensors that may exist within a system on a chip (“SoC”). For ease of explanation, some of the illustrations in this specification primarily include just a pair of thermal sensors which are affected by a pair of thermal aggressors in the form of a CPU and GPU; however, it will be understood that any number of thermal aggressors and thermal sensors may be the subject of a multi-correlative learning thermal management policy.

As a non-limiting example of how a multi-correlative thermal management approach may be applied to a family of thermal aggressors in an exemplary PCD, assume that a discrete number of bin settings, i.e. performance levels, P1, P2, P3, P4 . . . P15 (where P15 represents a maximum performance level and P1 represents a lowest performance level) have been defined for each of a pair of thermal aggressors. As one of ordinary skill in the art would understand, level P15 may be associated with both a high QoS level and a high thermal energy generation level for a given workload burden. Similarly, for the same workload burden, level P1 may be associated with both a low QoS level and a low thermal energy generation level. Assume also that a target temperature for a given temperature sensor, Sensor 1, has been set at 60° C.

In the non-limiting example, sampling of the temperature sensor may begin after a temperature reading is recognized to have exceeded the 60° C. target temperature. It is envisioned that, in some embodiments, triggering the initiation of sensor sampling for multi-correlative learning purposes may be accomplished by the use of interrupt based sensors. Once the interrupt is generated, an MLTM module may identify previously learned combinations of performance settings for the thermal aggressors which, if applied, would cause the temperature reading to fall and stabilize at the target temperature (assuming that the ambient temperature to which the PCD is exposed is substantially unchanged from when the settings combinations were learned). Based on the multi-correlation between the active aggressors' bin settings and the valid bin settings' combinations in the thermal settings database, together with the resulting temperature's relative closeness to the target temperature, the MLTM may select an optimum bin setting combination that is best suited for the use case and then cause the active performance settings of the thermal aggressors to be modified to the selected optimum bin setting combination.

Returning to the example, if an optimum bin setting combination has not been previously learned by the MLTM module for the 60° C. target temperature, the MLTM module may seek an optimum bin setting combination. The initial mitigation table used by the MLTM module for Sensor 1 may indicate that the bin settings for Thermal Aggressor 1 and Thermal Aggressor 2 should be set at the lowest bin level for each target temperature, including the exemplary 60° C. target temperature (the Default Mitigation Table for Sensor 1). As such, when any one of those target temperatures is exceeded for the first time, the MLTM module will reference the mitigation table and see that the bin setting combination for the thermal aggressors includes each being set to the minimum bin setting. The MLTM module may then cause the active bin settings for both of Thermal Aggressors 1 and 2 to be changed to its minimum bin setting, thus substantially reducing, if not eliminating, all thermal energy being generated by the thermal aggressors. Consequently, the temperature measured by the sensor may begin to drop and, if the bin settings remain at the minimum settings, stabilize at a temperature that is substantially in equilibrium with the ambient environment temperature of the PCD.

As the temperature measured by Sensor 1 drops, a heat dissipation curve may be mapped by the MLTM module (time versus temperature). Similarly, as the temperature measured by other temperature sensors also drops, a heat dissipation curve associated with each of those sensors may also be mapped. From the heat dissipation curves, the MLTM module may be able to estimate in future applications how long it will take a given sensor to reach any target temperature, assuming the ambient temperature is consistent with the ambient temperature at the time of developing the heat dissipation curve and the bin settings for each thermal aggressor were set to minimum levels. For illustrative purposes, a default mitigation table associated with the given sensor and used by the MLTM module in this example may be:

Default Mitigation Table for Sensor 1

| | Thermal | Thermal |
|---|---|---|
| Sensor 1 | Aggressor 1 | Aggressor 2 |
| measured Temp. | Bin Setting | Bin Setting |
| T = 90 | P1 | P1 |
| T = 80 | P1 | P1 |
| T = 70 | P1 | P1 |
| T = 60 | P1 | P1 |
| T = 50 | P1 | P1 |
| T = 40 | P1 | P1 |
| T = 30 | P1 | P1 |
| T = 20 | P1 | P1 |

From the illustrative Default Mitigation Table for Sensor 1 above, in response to a temperature threshold of 60° C. being exceeded at Sensor 1, the MLTM module may apply the default bin setting combination of P1 for both thermal aggressors. Consequently, the thermal energy being generated by the power consumption of the thermal aggressors will drastically reduce, thereby causing the temperature measured by Sensor 1 (as well as other monitored sensors) to drop. However, because setting the bin levels of the thermal aggressors to P1 may inevitably represent a more drastic power level reduction than necessary for maintaining the temperature measured by Sensor 1 at 60° C., the temperature may drop quickly to levels below 60° C.

Returning to the example from the view of Sensor 1, once the temperature measured by the Sensor 1 stabilizes, the MLTM module may recognize the reading as substantially equivalent to the ambient temperature to which the PCD is exposed. The MLTM module may then systematically increment the bin settings of Thermal Aggressors 1 and 2 and measure the impact of their resulting increase in thermal energy generation on the temperature measurement each sensor, including by Sensor 1. As the bin setting combinations are incremented, the MLTM module may build a database of valid bin setting combinations for the thermal aggressors in association with the sensors, various target temperatures and the determined ambient temperature. Advantageously, the valid bin setting combinations may be queried by the MLTM module in future scenarios to identify an optimum bin setting combination for the particular target temperatures of one or more sensors.

From the valid bin setting combinations identified by the MLTM module to stabilize the temperature measurement at the various target temperatures, the MLTM module may select an optimum bin setting combination for each. The optimum bin setting combination may be selected based on its multi-correlation with the active aggressors' bin settings combination at the time of the thermal event as well as the relative closeness between the resulting temperature and the target temperature. For instance, if Aggressor 1 is running at level P6 and Aggressor 2 is running at level P2 at the time of the thermal event, the MLTM module may select an optimum bin setting combination that is close to the P6/P2 settings. That is, if a valid bin setting combination has both Aggressors running at P3 while another valid bin setting combination has the Aggressors running at P5 and P2, respectively, then the MLTM module may elect to apply the bin setting combination P5/P2 as it is closest to the P6/P2 setting that was active at the time of the thermal event. In selecting an optimum bin setting combination in this manner, the MLTM module may recognize that the active bin setting combination at the time of the thermal event was driven by an ongoing use case and, as such, seek to select a new optimum bin setting combination from all valid bin setting combinations that is most likely to be compatible with the ongoing use case of the PCD.

Returning to the example, the default bin setting combinations in the mitigation table for the target temperature may then be replaced with the optimum bin setting combination. For illustrative purposes, the above Default Mitigation Table for Sensor 1 may be updated by the MLTM module based on the iterative learning process describe above. Notably, a default mitigation table for other sensors may also be updated. The resulting Updated Mitigation Table for Sensor 1 may be:

Updated Mitigation Table for Sensor 1

| | Thermal | Thermal |
|---|---|---|
| Sensor 1 | Aggressor 1 | Aggressor 2 |
| measured Temp. | Bin Setting | Bin Setting |
| T = 90 | P6 | P5 |
| T = 80 | P5 | P5 |
| T = 70 | P5 | P4 |
| T = 60 | P4 | P3 |
| T = 50 | P2 | P3 |
| T = 40 | P2 | P2 |
| T = 30 | P2 | P1 |
| T = 20 | P1 | P1 |

The MLTM module may then apply the optimum bin setting combination, P4 for Thermal Aggressor 1 and P3 for Thermal Aggressor 2, thereby causing the thermal energy levels measured by Sensor 1 to mitigate toward, and stabilize at, the target temperature of 60° C. Notably, the optimum bin setting combination of P4 for Thermal Aggressor 1 and P3 for Thermal Aggressor 2 may also have been selected by the MLTM module based on a recognition that such bin setting combination would not cause target temperatures associated with other sensors to be exceeded. Advantageously, in future scenarios where the MLTM module receives notification that one of the target temperatures learned in Updated Mitigation Table for Sensor 1 has been exceeded, a query of the table will inform the MLTM module to immediately apply the previously learned optimum bin setting combination.

Also, because the Updated Mitigation Table for Sensor 1 includes optimum settings combinations for multiple target temperatures at the determined ambient temperature, one of ordinary skill in the art will recognize that the difference between a given target temperature and the ambient temperature represents the amount of thermal energy measured by the sensor that is attributable to the thermal aggressors. With this recognition, the MLTM module may “shift” the optimum bin setting combinations up or down the mitigation table when a change in ambient temperature is recognized.

For example, in the Updated Mitigation Table for Sensor 1 above, it can be seen that for a target temperature of 20° C. the bin setting for both thermal aggressors should be set to P1. Therefore, in the example, the MLTM module may deduce that the ambient environment temperature when the bin setting combinations were learned was also 20° C. Consequently, an expanded Updated Mitigation Table for Sensor 1 may include a column that indicates the thermal energy contribution attributable to each bin setting combination listed in the Updated Mitigation Table for Sensor 1:

Updated Mitigation Table for Sensor 1

| | Thermal | Thermal | Thermal |
|---|---|---|---|
| Sensor 1 | Aggressor 1 | Aggressor 2 | Aggressor Energy |
| measured Temp. | Bin Setting | Bin Setting | Contribution |
| T = 90° C. | P6 | P5 | 70° C. |
| T = 80° C. | P5 | P5 | 60° C. |
| T = 70° C. | P5 | P4 | 50° C. |
| T = 60° C. | P4 | P3 | 40° C. |
| T = 50° C. | P2 | P3 | 30° C. |
| T = 40° C. | P2 | P2 | 20° C. |
| T = 30° C. | P2 | P1 | 10° C. |
| T = 20° C. | P1 | P1 | 0° C. |

Returning to the example, the MLTM module having selected and applied an optimum bin setting combination of P4 for Thermal Aggressor 1 and P3 for Thermal Aggressor 2 may work with a monitor module to monitor the rate at which the operating temperature approaches the target temperature to build a heat dissipation curve associated with the settings.

Using the heat dissipation data, when the bin setting combination of P4 for Thermal Aggressor 1 and P3 for Thermal Aggressor 2 is used in future applications, the MLTM module may expect the thermal energy to dissipate within a certain amount of time consistent with past learning. Notably, if the target temperature is reached faster than expected, the MLTM module may deduce that the ambient environment to which the PCD is presently exposed is cooler than the ambient environment to which it was exposed when the selected optimum bin setting combination was learned (i.e., cooler than 20° C.). Similarly, if the operating temperature measured by the temperature sensor stabilizes at a temperature higher than the target temperature, the MLTM module may deduce that the ambient environment to which the PCD is presently exposed is warmer than the ambient environment to which it was exposed when the selected optimum bin setting combination was learned (i.e., warmer than 20° C.). Either way, embodiments of an MLTM system and method may calculate the change in ambient temperature based on the known temperature contribution of the thermal aggressors (i.e., thermal aggressor energy contribution) associated with the selected optimum bin setting combination.

For example, in the above illustration the thermal aggressor energy contribution was calculated to be 40° C. when the bin setting combination was set to P4 for Thermal Aggressor 1 and P3 for Thermal Aggressor 2. As such, if the same bin setting combination results in an operating temperature measurement that is 70° C., the MLTM module may attribute the additional 10° C. to the ambient environment and update the mitigation table by “shifting” the optimum bin setting combinations up a level. In the example, shifting the bin setting combinations up a level in response to recognizing that the ambient temperature has increased from 20° C. to 30° C. will result in the following:

Second Iteration Updated Mitigation Table for Sensor 1

| | Thermal | Thermal | Thermal |
|---|---|---|---|
| Sensor 1 | Aggressor 1 | Aggressor 2 | Aggressor Energy |
| measured Temp. | Bin Setting | Bin Setting | Contribution |
| T = 90° C. | P5 | P5 | 60° C. |
| T = 80° C. | P5 | P4 | 50° C. |
| T = 70° C. | P4 | P3 | 40° C. |
| T = 60° C. | P2 | P3 | 30° C. |
| T = 50° C. | P2 | P2 | 20° C. |
| T = 40° C. | P2 | P1 | 10° C. |
| T = 30° C. | P1 | P1 | 0° C. |
| T = 20° C. | P1 | P1 | 0° C. |

The MLTM module may continue to use the above Mitigation Table for selection and application of optimum bin setting combinations until another ambient environment temperature change is recognized and/or a target temperature not yet learned is exceeded at the Sensor 1 and/or a different use case triggers the need for more learning and/or there is a change in the operating specifications of one of the thermal aggressors. Notably, although embodiments of a multi-correlative learning thermal management method may be described herein with reference to a single sensor, it is envisioned that the same or similar algorithm may be applied simultaneously, or sequentially, in association with other sensors within the PCD.

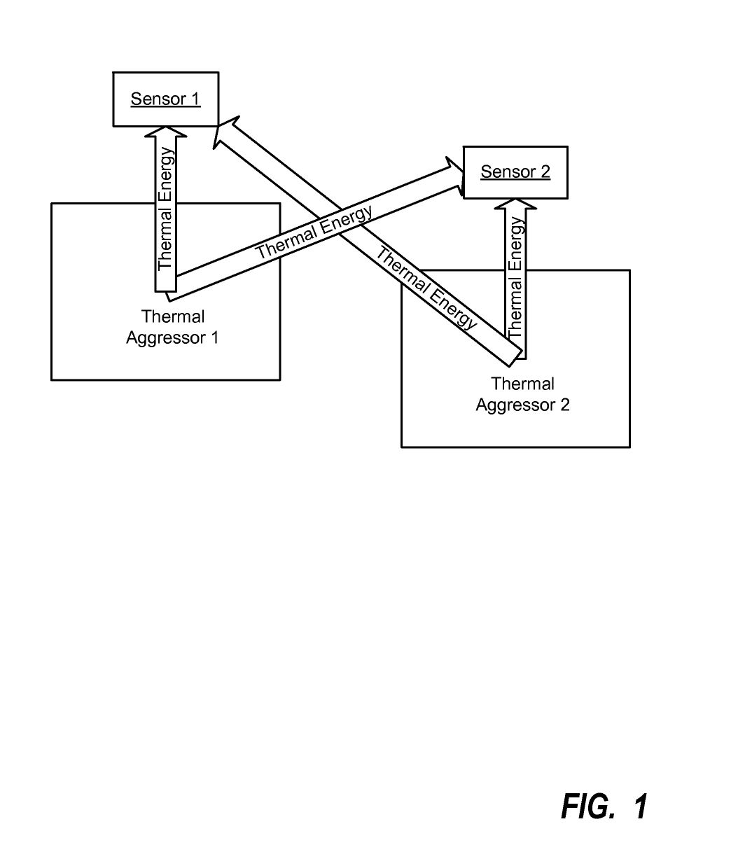

FIG. 1 is an illustration of exemplary thermal dynamics that may occur between multiple thermal aggressors and multiple temperature sensors in a system on a chip (“SOC”). As can be seen from the FIG. 1 illustration, thermal energy generated by both thermal aggressors may contribute to temperature readings taken by each of the thermal sensors. Because Sensor 1 in the illustration is closer to Thermal Aggressor 1, the thermal energy measured by Sensor 1 may be largely attributable to Thermal Aggressor 1. However, as one of ordinary skill in the art would recognize, Thermal Aggressor 2 may also generate thermal energy that affects the measurements taken by Sensor 1. Similarly, the thermal energy generated by Thermal Aggressor 1 may affect the temperature readings taken by Sensor 2, although perhaps not as much as the thermal energy generated by Aggressor 2 which is closer.

Even so, and as one of ordinary skill in the art would recognize, if Thermal Aggressor 2, for example, were set at a particularly low bin setting (therefore consuming relatively little power) and Thermal Aggressor 1 set at a relatively high bin level, the amount of thermal energy measured by Sensor 2 may be largely attributable to Thermal Aggressor 1 even though it is farther away from Sensor 2 on the chip than Thermal Aggressor 2. Advantageously, embodiments of the MLTM systems and methods recognize the reality that various combinations of bin settings for multiple thermal aggressors may produce the same thermal energy measurement at a given sensor under the same operating and ambient conditions. By taking into account that multiple bin setting combinations may produce the same result, as measured by a given temperature sensor, an MLTM module may select a specific bin setting combination that is best suited for an active use case.

As mentioned above, embodiments of the MLTM systems and methods recognize that thermal energy levels measured by sensors in an SOC, such as Sensor 1 and Sensor 2 in the FIG. 1 illustration, may be attributable to multiple thermal aggressors. Notably, the FIG. 1 illustration is offered for explanatory purposes only and is not meant to suggest that embodiments of an MLTM system or method are limited to applying MLTM solutions in applications that include only pairs of thermal aggressors and sensors. It is envisioned that embodiments of the systems and methods may be applicable to any combination of thermal aggressors and sensors that reside within a PCD.

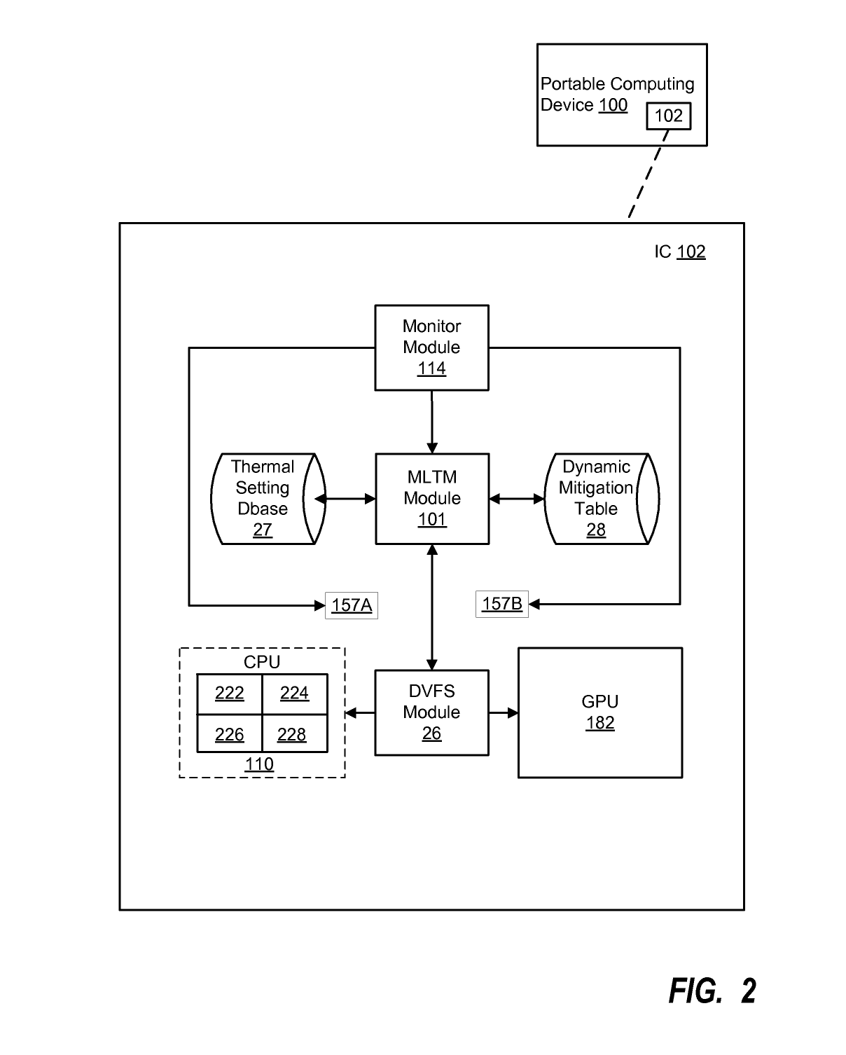

FIG. 2 is a functional block diagram illustrating an embodiment of an on-chip system 102 for implementing multi-correlative learning thermal management (“MLTM”) methodologies in a PCD 100. An MLTM system and method seeks to learn valid bin setting combinations for all thermal aggressor combinations on a chip that may bring temperatures measured by thermal sensors on the chip as close as possible to designated target temperatures within a target time.

In the FIG. 2 illustration, temperature sensors 157A and 157B are located on the chip 102 such that thermal energy measured by each may be attributable to energy produced by, and dissipated from, each of thermal aggressors GPU 182 and multi-processor CPU 110, which includes cores 222, 224, 226 and 228. Notably, and as mentioned above, embodiments of a multi-correlative learning thermal management methodology are not limited to applications of two thermal sensors and two thermal aggressors. It is envisioned that embodiments may accommodate far more complex multi-correlative environments where a plurality of thermal aggressors located around a chip may affect at various levels the temperatures measured by each of a plurality of temperature sensors. Moreover, one of ordinary skill in the art will recognize that embodiments of a multi-correlative learning thermal management methodology is not limited in application to thermal aggressors in the form of CPUs and GPUs but, rather, may be applied to any combination of thermal aggressors such as, but not limited to, modems, display components, wireless LAN components, etc.

In general, the system 102 employs two main modules which, in some embodiments, may be contained in a single module: (1) an multi-correlative learning thermal management (“MLTM”) module 101 for analyzing temperature readings monitored by a monitor module 114 (notably, monitor module 114 and MLTM module 101 may be one and the same in some embodiments) and determining and selecting optimum bin setting combinations; and (2) a bin setting module such as, but not limited to, a DVFS module 26 for implementing incremental throttling strategies on individual processing components according to instructions received from MLTM module 101.

Upon receiving a trigger from one of the sensors 157 that a target temperature threshold has been exceeded, the MLTM module 101 may determine from a query of Thermal Setting Database 27 that valid bin setting combinations have not previously been learned in association with the target temperature. If so, the MLTM module 101 may trigger an iterative learning process that determines the ambient temperature of the PCD 100 and systematically identifies valid bin setting combinations for maintaining temperatures of the sensors 157 at various levels. From the valid bin setting combinations, the MLTM module 101 may update the Dynamic Mitigation Table 28 to include the optimum bin setting combinations and then instruct the dynamic voltage and frequency scaling (“DVFS”) module 26 to set the bins of the GPU 182 and CPU 110 (or certain cores 222, 224, 226, 228) at levels that will maintain the target temperature.

Using its knowledge of the heat dissipation rates of the various bin setting combinations in association with the ambient environment temperature, the MLTM module 101 may be able to recognize an increase or decrease in the ambient temperature after application of a bin setting combination previously learned. Based on the extent of the increase or decrease in the temperature of the ambient environment to which the PCD 100 is exposed, the heat dissipation rate may not be acceptable to maintain a target QoS level. In such case, the MLTM module 101 may iteratively determine new bin setting combinations in the Thermal Setting Database 27 or apply bin setting combinations associated in the Dynamic Mitigation Table with other target temperatures.

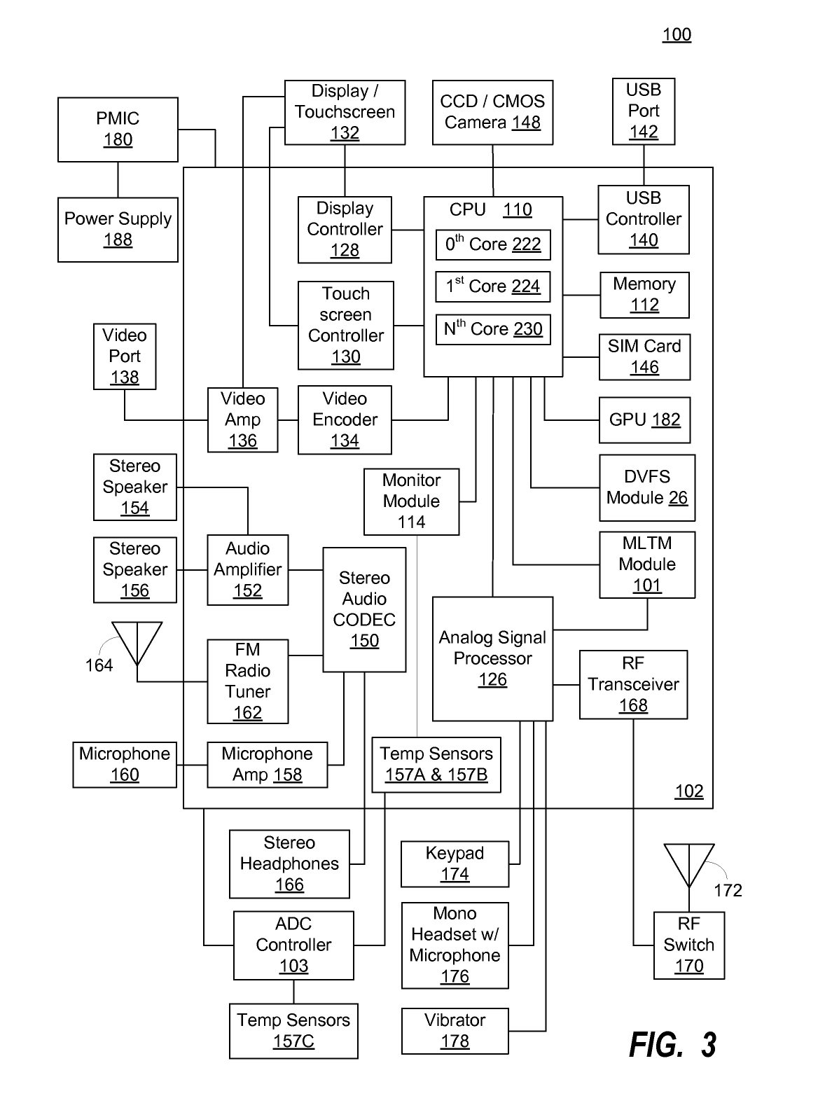

FIG. 3 is a functional block diagram illustrating an exemplary, non-limiting aspect of the PCD of FIG. 2 in the form of a wireless telephone for implementing methods and systems for multi-correlative learning thermal management of multiple processing components through learned optimal settings associated with target temperatures of multiple thermal sensors. As shown, the PCD 100 includes an on-chip system 102 that includes a multi-core central processing unit (“CPU”) 110 and an analog signal processor 126 that are coupled together. The CPU 110 may comprise a zeroth core 222, a first core 224, and an Nth core 230 as understood by one of ordinary skill in the art. Further, instead of a CPU 110, a digital signal processor (“DSP”) may also be employed as understood by one of ordinary skill in the art.

In general, the dynamic voltage and frequency scaling (“DVFS”) module 26 may be responsible for implementing throttling techniques to individual processing components, such as cores 222, 224, 230 in an incremental fashion to help a PCD 100 optimize its power level and maintain a high level of functionality without detrimentally exceeding certain temperature thresholds.

The monitor module 114 communicates with multiple operational sensors (e.g., thermal sensors 157A, 157B) distributed throughout the on-chip system 102 and with the CPU 110 of the PCD 100 as well as with the MLTM module 101. In some embodiments, monitor module 114 may also monitor “off-chip” sensors 157C for temperature readings associated with a touch temperature of PCD 100. The MLTM module 101 may work with the monitor module 114 to identify temperature thresholds that have been exceeded and, using multi-correlative learning thermal management algorithms, instruct the application of throttling strategies to identified components within chip 102 in an effort to reduce the temperatures.

As illustrated in FIG. 3, a display controller 128 and a touch screen controller 130 are coupled to the digital signal processor 110. A touch screen display 132 external to the on-chip system 102 is coupled to the display controller 128 and the touch screen controller 130. PCD 100 may further include a video encoder 134, e.g., a phase-alternating line (“PAL”) encoder, a sequential couleur avec memoire (“SECAM”) encoder, a national television system(s) committee (“NTSC”) encoder or any other type of video encoder 134. The video encoder 134 is coupled to the multi-core central processing unit (“CPU”) 110. A video amplifier 136 is coupled to the video encoder 134 and the touch screen display 132. A video port 138 is coupled to the video amplifier 136. As depicted in FIG. 3, a universal serial bus (“USB”) controller 140 is coupled to the CPU 110. Also, a USB port 142 is coupled to the USB controller 140. A memory 112 and a subscriber identity module (SIM) card 146 may also be coupled to the CPU 110. Further, as shown in FIG. 3, a digital camera 148 may be coupled to the CPU 110. In an exemplary aspect, the digital camera 148 is a charge-coupled device (“CCD”) camera or a complementary metal-oxide semiconductor (“CMOS”) camera.

As further illustrated in FIG. 3, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 3 shows that a microphone amplifier 158 may also be coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 3 further indicates that a radio frequency (“RF”) transceiver 168 may be coupled to the analog signal processor 126. An RF switch 170 may be coupled to the RF transceiver 168 and an RF antenna 172. As shown in FIG. 3, a keypad 174 may be coupled to the analog signal processor 126. Also, a mono headset with a microphone 176 may be coupled to the analog signal processor 126. Further, a vibrator device 178 may be coupled to the analog signal processor 126. FIG. 3 also shows that a power supply 188, for example a battery, is coupled to the on-chip system 102 through PMIC 180. In a particular aspect, the power supply includes a rechargeable DC battery or a DC power supply that is derived from an alternating current (“AC”) to DC transformer that is connected to an AC power source.

The CPU 110 may also be coupled to one or more internal, on-chip thermal sensors 157A, 157B as well as one or more external, off-chip thermal sensors 157C. The on-chip thermal sensors 157 may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157 may comprise one or more thermistors. The thermal sensors 157 may produce a voltage drop that is converted to digital signals with an analog-to-digital converter (“ADC”) controller 103. However, other types of thermal sensors 157A, 157B, 157C may be employed without departing from the scope of the invention.

The DVFS module(s) 26 and MLTM module(s) 101 may comprise software which is executed by the CPU 110. However, the DVFS module(s) 26 and MLTM module(s) 101 may also be formed from hardware and/or firmware without departing from the scope of the invention. The MLTM module(s) 101 in conjunction with the DVFS module(s) 26 may be responsible for applying throttling policies that may help a PCD 100 avoid thermal degradation while maintaining a high level of functionality and user experience.

The touch screen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, the power supply 188, the PMIC 180 and the thermal sensors 157C are external to the on-chip system 102. However, it should be understood that the monitor module 114 may also receive one or more indications or signals from one or more of these external devices by way of the analog signal processor 126 and the CPU 110 to aid in the real time management of the resources operable on the PCD 100.

In a particular aspect, one or more of the method steps described herein may be implemented by executable instructions and parameters stored in the memory 112 that form the one or more MLTM module(s) 101 and DVFS module(s) 26. These instructions that form the module(s) 101, 26 may be executed by the CPU 110, the analog signal processor 126, or another processor, in addition to the ADC controller 103 to perform the methods described herein. Further, the processors 110, 126, the memory 112, the instructions stored therein, or a combination thereof may serve as a means for performing one or more of the method steps described herein.

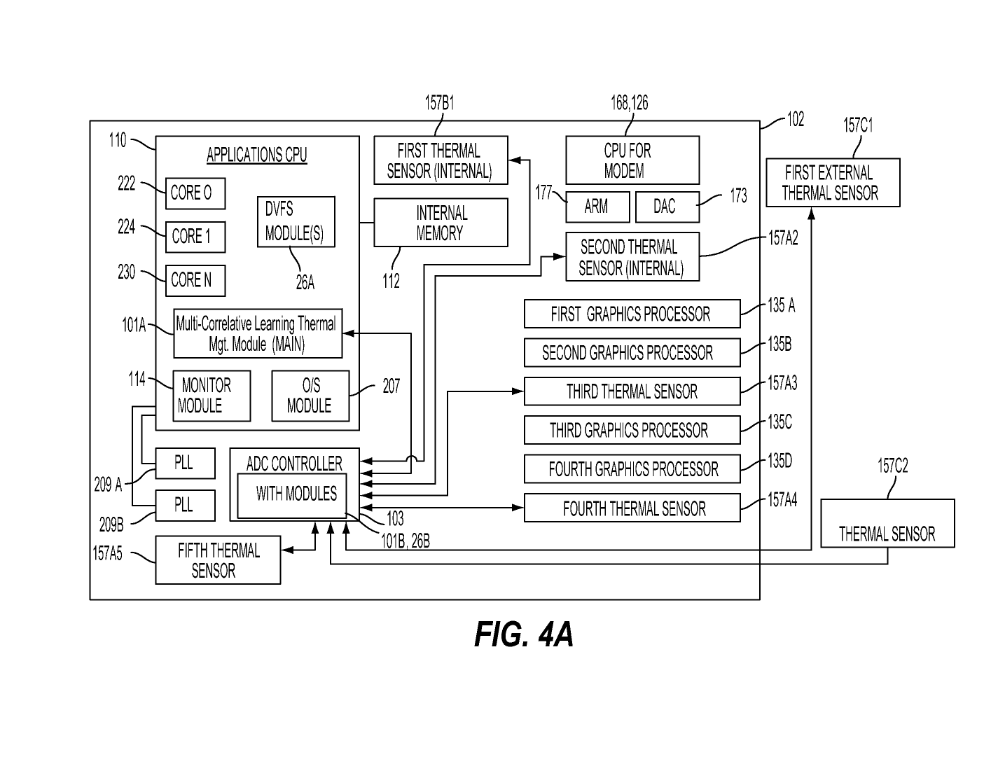

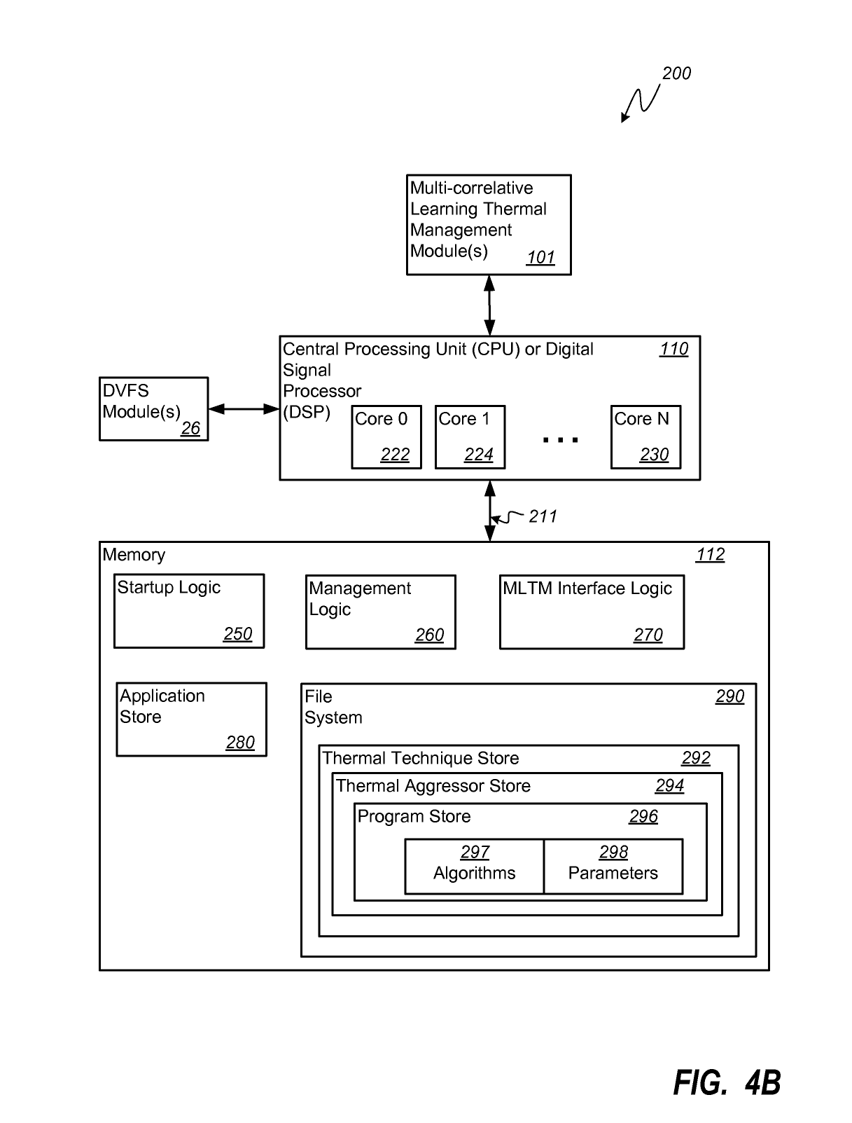

FIG. 4A is a functional block diagram illustrating an exemplary spatial arrangement of hardware for the chip 102 illustrated in FIG. 3. According to this exemplary embodiment, the applications CPU 110 is positioned on the far left side region of the chip 102 while the modem CPU 168, 126 is positioned on a far right side region of the chip 102. The applications CPU 110 may comprise a multi-core processor that includes a zeroth core 222, a first core 224, and an Nth core 230. The applications CPU 110 may be executing an MLTM module 101A and/or DVFS module 26A (when embodied in software) or it may include an MLTM module 101A and/or DVFS module 26A (when embodied in hardware). The application CPU 110 is further illustrated to include operating system (“O/S”) module 207 and a monitor module 114.

The applications CPU 110 may be coupled to one or more phase locked loops (“PLLs”) 209A, 209B, which are positioned adjacent to the applications CPU 110 and in the left side region of the chip 102. Adjacent to the PLLs 209A, 209B and below the applications CPU 110 may comprise an analog-to-digital (“ADC”) controller 103 that may include its own MLTM module 101B and/or DVFS module 26B that works in conjunction with the main modules 101A, 26A of the applications CPU 110.

The MLTM module 101B of the ADC controller 103 may be responsible for monitoring and tracking multiple thermal sensors 157 that may be provided “on-chip” 102 and “off-chip” 102. The on-chip or internal thermal sensors 157A, 157B may be positioned at various locations and associated with thermal aggressor(s) proximal to the locations (such as with sensor 157A3 next to second and third thermal graphics processors 135B and 135C) or temperature sensitive components (such as with sensor 157B1 next to memory 112). As noted above, however, although a given sensor may be physically proximate to a given thermal aggressor, the temperature measured by that sensor may be attributable to multiple thermal aggressors located around the chip 102. Moreover, the relative amount of thermal energy attributable to a given thermal aggressor and measured by a given thermal sensor may be a function of the bin setting of the thermal aggressor.

As a non-limiting example, a first internal thermal sensor 157B1 may be positioned in a top center region of the chip 102 between the applications CPU 110 and the modem CPU 168,126 and adjacent to internal memory 112. A second internal thermal sensor 157A2 may be positioned below the modem CPU 168, 126 on a right side region of the chip 102. This second internal thermal sensor 157A2 may also be positioned between an advanced reduced instruction set computer (“RISC”) instruction set machine (“ARM”) 177 and a first graphics processor 135A. A digital-to-analog controller (“DAC”) 173 may be positioned between the second internal thermal sensor 157A2 and the modem CPU 168, 126.

A third internal thermal sensor 157A3 may be positioned between a second graphics processor 135B and a third graphics processor 135C in a far right region of the chip 102. A fourth internal thermal sensor 157A4 may be positioned in a far right region of the chip 102 and beneath a fourth graphics processor 135D. And a fifth internal thermal sensor 157A5 may be positioned in a far left region of the chip 102 and adjacent to the PLLs 209 and ADC controller 103.

One or more external thermal sensors 157C may also be coupled to the ADC controller 103. The first external thermal sensor 157C1 may be positioned off-chip and adjacent to a top right quadrant of the chip 102 that may include the modem CPU 168, 126, the ARM 177, and DAC 173. A second external thermal sensor 157C2 may be positioned off-chip and adjacent to a lower right quadrant of the chip 102 that may include the third and fourth graphics processors 135C, 135D. Notably, one or more of external thermal sensors 157C may be leveraged to indicate the touch temperature of the PCD 100, i.e. the temperature that may be experienced by a user in contact with the PCD 100.

One of ordinary skill in the art will recognize that various combinations of bin settings for the processing components outlined above and depicted in the FIG. 4A illustration may affect the temperature measured by each of the various temperature sensors. Embodiments of multi-correlative learning thermal management systems and methods recognize the interplay of thermal aggressors and temperature measurements around a chip and seek to optimize bin setting combinations of the thermal aggressors to efficiently manage thermal energy generation and optimize QoS.

One of ordinary skill in the art will recognize that various other spatial arrangements of the hardware illustrated in FIG. 4A may be provided without departing from the scope of the invention. FIG. 4A illustrates yet one exemplary spatial arrangement and how the main MLTM and DVFS modules 101A, 26A and ADC controller 103 with its MLTM and DVFS modules 101B, 26B may recognize thermal conditions that are a function of the exemplary spatial arrangement illustrated in FIG. 4A, compare temperature thresholds with operating temperatures and apply multi-correlative learning thermal management policies.

FIG. 4B is a schematic diagram illustrating an exemplary software architecture of the PCD of FIG. 3 for multi-correlative learning thermal management. Any number of algorithms may form or be part of at least one thermal management policy that may be applied by the MLTM module 101 when certain thermal conditions are met, however, in a preferred embodiment the MLTM module 101 works with the DVFS module 26 to incrementally apply voltage and frequency scaling policies to individual thermal aggressors in chip 102 including, but not limited to, cores 222, 224 and 230. From the incremental scaling efforts, the MLTM module identifies valid combinations of bin settings for multiple thermal aggressors necessary to maintain various monitored temperature levels.

As illustrated in FIG. 4B, the CPU or digital signal processor 110 is coupled to the memory 112 via a bus 211. The CPU 110, as noted above, is a multiple-core processor having N core processors. That is, the CPU 110 includes a first core 222, a second core 224, and an N^{th} core 230. As is known to one of ordinary skill in the art, each of the first core 222, the second core 224 and the N^{th} core 230 are available for supporting a dedicated application or program. Alternatively, one or more applications or programs may be distributed for processing across two or more of the available cores.

The CPU 110 may receive commands from the MLTM module(s) 101 and/or DVFS module(s) 26 that may comprise software and/or hardware. If embodied as software, the module(s) 101, 26 comprise instructions that are executed by the CPU 110 that issues commands to other application programs being executed by the CPU 110 and other processors.

The first core 222, the second core 224 through to the Nth core 230 of the CPU 110 may be integrated on a single integrated circuit die, or they may be integrated or coupled on separate dies in a multiple-circuit package. Designers may couple the first core 222, the second core 224 through to the N^{th} core 230 via one or more shared caches and they may implement message or instruction passing via network topologies such as bus, ring, mesh and crossbar topologies.

Bus 211 may include multiple communication paths via one or more wired or wireless connections, as is known in the art. The bus 211 may have additional elements, which are omitted for simplicity, such as controllers, buffers (caches), drivers, repeaters, and receivers, to enable communications. Further, the bus 211 may include address, control, and/or data connections to enable appropriate communications among the aforementioned components.

When the logic used by the PCD 100 is implemented in software, as is shown in FIG. 4B, it should be noted that one or more of startup logic 250, management logic 260, multi-correlative learning thermal management interface logic 270, applications in application store 280 and portions of the file system 290 may be stored on any computer-readable medium for use by, or in connection with, any computer-related system or method.

In the context of this document, a computer-readable medium is an electronic, magnetic, optical, or other physical device or means that can contain or store a computer program and data for use by or in connection with a computer-related system or method. The various logic elements and data stores may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, for instance via optical scanning of the paper or other medium, then compiled, interpreted or otherwise processed in a suitable manner if necessary, and then stored in a computer memory.

In an alternative embodiment, where one or more of the startup logic 250, management logic 260 and perhaps the MLTM interface logic 270 are implemented in hardware, the various logic may be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The memory 112 is a non-volatile data storage device such as a flash memory or a solid-state memory device. Although depicted as a single device, the memory 112 may be a distributed memory device with separate data stores coupled to the digital signal processor 110 (or additional processor cores).

The startup logic 250 includes one or more executable instructions for selectively identifying, loading, and executing a select program for managing or controlling the performance of one or more of the available cores such as the first core 222, the second core 224 through to the N^{th} core 230. The startup logic 250 may identify, load and execute a select program based on the comparison, by the MLTM module 101, of various temperature measurements with threshold temperature settings associated with a PCD component or aspect. An exemplary select program may be found in the program store 296 of the embedded file system 290 and is defined by a specific combination of a performance scaling algorithm 297 and a set of parameters 298. The exemplary select program, when executed by one or more of the core processors in the CPU 110 may operate in accordance with one or more signals provided by the monitor module 114 in combination with control signals provided by the one or more MLTM module(s) 101 and DVFS module(s) 26 to scale the performance of the respective processor core “up” or “down.” In this regard, the monitor module 114 may provide one or more indicators of events, processes, applications, resource status conditions, elapsed time, as well as temperature as received from the MLTM module 101.

The management logic 260 includes one or more executable instructions for terminating a MLTM program on one or more of the respective processor cores, as well as selectively identifying, loading, and executing a more suitable replacement program for managing or controlling the performance of one or more of the available cores. The management logic 260 is arranged to perform these functions at run time or while the PCD 100 is powered and in use by an operator of the device. A replacement program may be found in the program store 296 of the embedded file system 290 and, in some embodiments, may be defined by a specific combination of a performance scaling algorithm 297 and a set of parameters 298.

The replacement program, when executed by one or more of the core processors in the digital signal processor may operate in accordance with one or more signals provided by the monitor module 114 or one or more signals provided on the respective control inputs of the various processor cores to scale the performance of the respective processor core. In this regard, the monitor module 114 may provide one or more indicators of events, processes, applications, resource status conditions, elapsed time, temperature, etc in response to control signals originating from the MLTM 101.

The interface logic 270 includes one or more executable instructions for presenting, managing and interacting with external inputs to observe, configure, or otherwise update information stored in the embedded file system 290. In one embodiment, the interface logic 270 may operate in conjunction with manufacturer inputs received via the USB port 142. These inputs may include one or more programs to be deleted from or added to the program store 296. Alternatively, the inputs may include edits or changes to one or more of the programs in the program store 296. Moreover, the inputs may identify one or more changes to, or entire replacements of one or both of the startup logic 250 and the management logic 260. By way of example, the inputs may include a change to the available bin settings for a given thermal aggressor.

The interface logic 270 enables a manufacturer to controllably configure and adjust an end user's experience under defined operating conditions on the PCD 100. When the memory 112 is a flash memory, one or more of the startup logic 250, the management logic 260, the interface logic 270, the application programs in the application store 280 or information in the embedded file system 290 may be edited, replaced, or otherwise modified. In some embodiments, the interface logic 270 may permit an end user or operator of the PCD 100 to search, locate, modify or replace the startup logic 250, the management logic 260, applications in the application store 280 and information in the embedded file system 290. The operator may use the resulting interface to make changes that will be implemented upon the next startup of the PCD 100. Alternatively, the operator may use the resulting interface to make changes that are implemented during run time.

The embedded file system 290 includes a hierarchically arranged thermal technique store 292. In this regard, the file system 290 may include a reserved section of its total file system capacity for the storage of information for the configuration and management of the various parameters 298 and thermal management algorithms 297 used by the PCD 100. As shown in FIG. 4B, the store 292 includes a thermal aggressor store 294, which includes a program store 296, which includes one or more thermal management programs that may include a multi-correlative learning thermal management program.

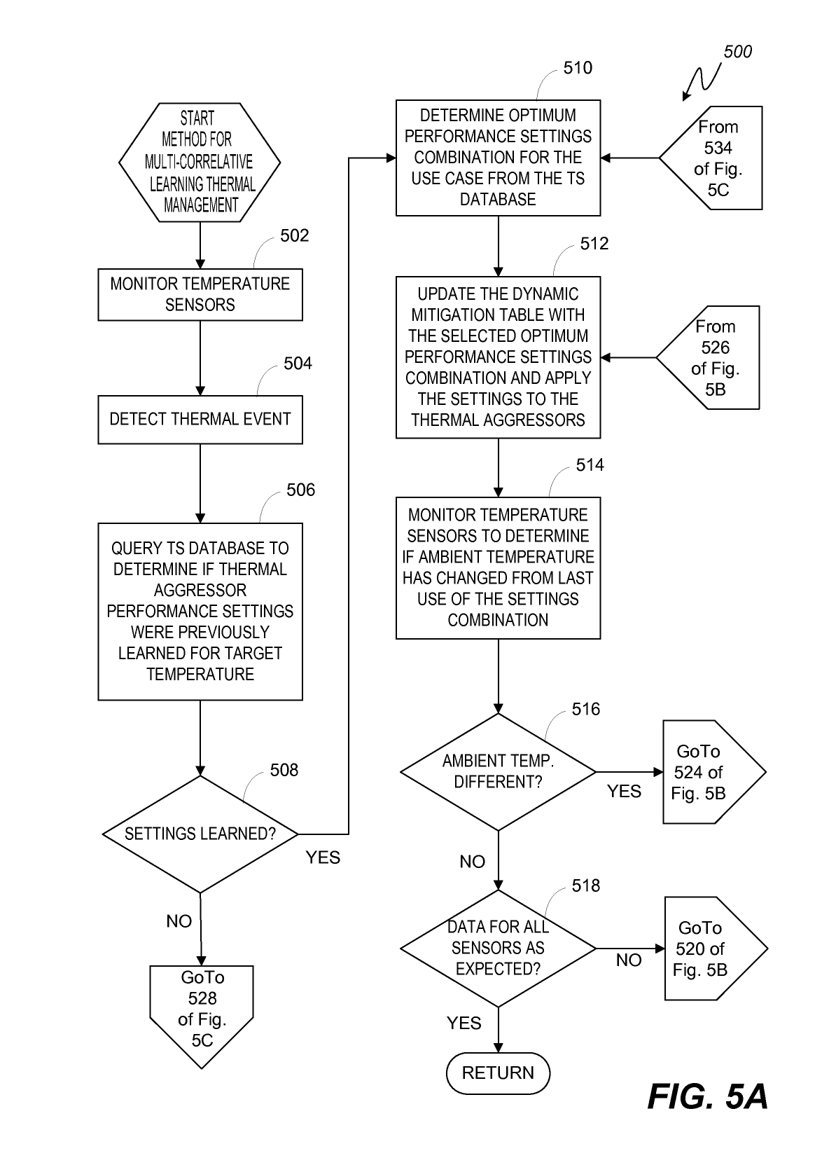

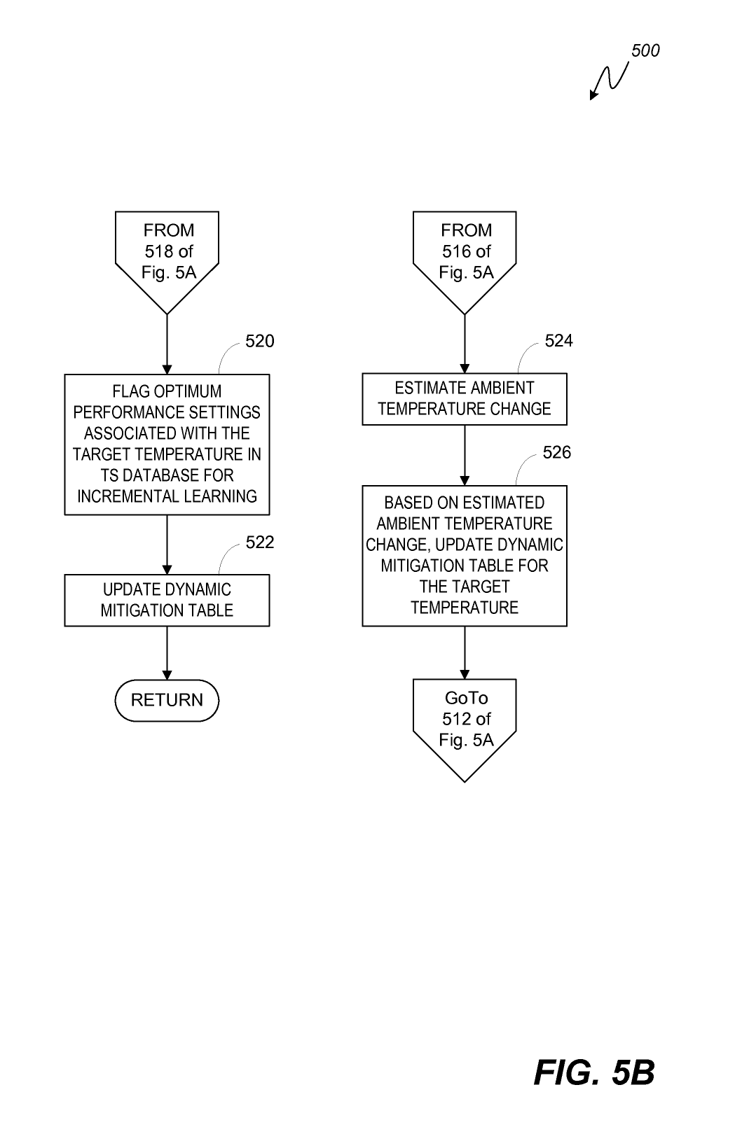

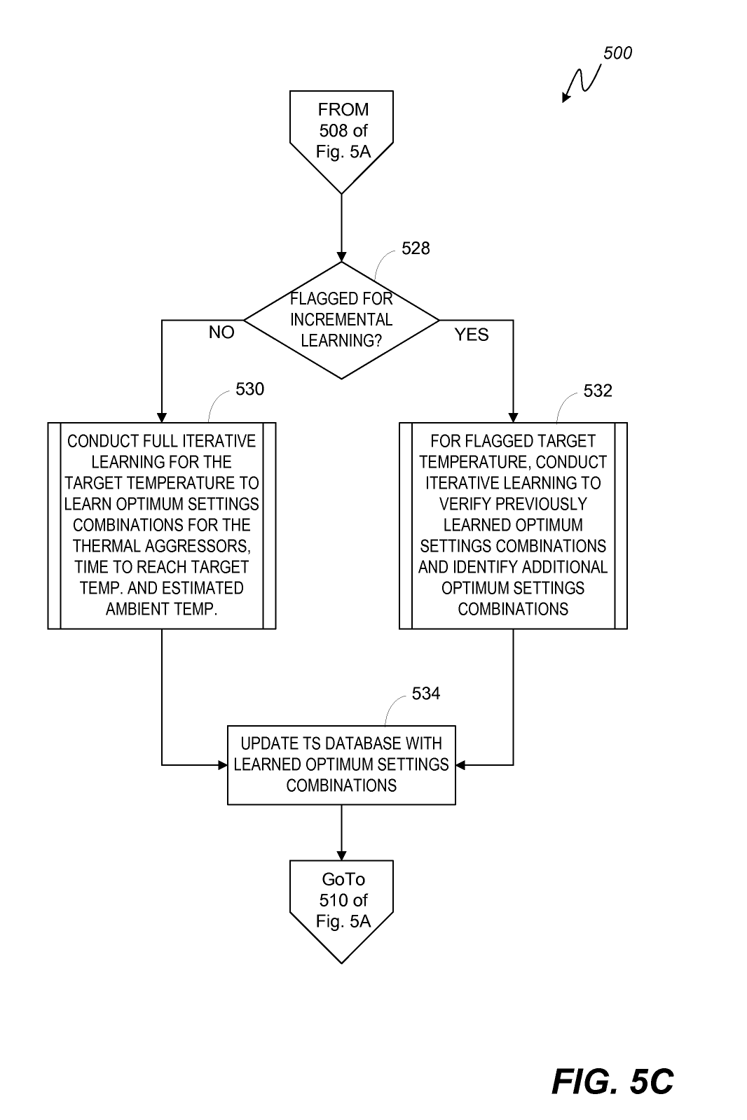

FIGS. 5A-5C are a logical flowchart illustrating a method 500 for managing thermal energy generation in the PCD of FIG. 2 through multi-correlative learning of the thermal dynamics between multiple thermal aggressors and multiple temperature sensors. Method 500 of FIG. 5 starts with a first block 502 in which one or more temperature sensors located around a chip are monitored. Acceptable temperature thresholds, i.e. target temperatures, may have been previously set for each of the sensors. At block 504 a thermal event in the form of a temperature reading in excess of a target temperature may be detected. At block 506, the MLTM module 101 may query the Thermal Settings Database to determine whether valid bin setting combinations for various thermal aggressors known to affect the thermal event have been previously learned.

If so, the “yes” branch is followed to block 510 and an optimum bin setting combination is selected for application. Notably, the MLTM module 101 may have previously learned, and stored in the TS Database 27 multiple valid bin setting combinations for the thermal event detected at block 504. It is envisioned that the optimum bin setting combination selected from all the valid combinations previously learned may be associated, by multi-correlation, with the particular use case active at the time of the thermal event. For example, if the active use case were a gaming application, an optimum bin setting combination may include a bin setting for a GPU component that is high and a bin setting for a core in CPU 110 that is relatively low.

Returning to the method 500, at block 512 the Dynamic Mitigation Table 28 is updated with the optimum bin setting combination selected at block 510 and the bin settings are applied to the thermal aggressors associated with the thermal event. At block 514, the rate of thermal energy dissipation is monitored in an effort to verify that the ambient environment temperature to which the PCD 100 is exposed has not changed since the optimum bin setting combination was learned and last applied. At decision block 516, if the ambient temperature is consistent with the previous ambient temperature, the “no” branch is followed to decision block 518. At decision block 518, if each sensor monitored by the MLTM module 101 recorded thermal dissipation rates in response to the bin setting combination that were consistent with the last application of that bin setting combination, then the MLTM module deduces that there have been no changes to the health or performance specs of the thermal aggressors and the “yes” branch is followed to return.

Returning to decision block 516, if the ambient temperature is not consistent with the previous ambient temperature, the “yes” branch is followed to decision block 524 of FIG. 5B. At block 524, the ambient temperature change is estimated. Based on the ambient temperature change, at block 526 the MLTM module 101 may update the Dynamic Mitigation Table by shifting the previously learned bin setting combinations “up” or “down” in association with the target temperatures. As described above, because the MLTM module 101 may be able to calculate the amount of thermal energy attributable to the thermal aggressors under a given bin setting combination scheme, the bin setting combinations in association with the updated ambient temperature may be mapped to target temperatures in the Dynamic Mitigation Table. The MLTM module 101 may continue to use the updated Table until another indication in ambient environment is identified. Subsequent to block 526, the method 500 returns to block 512 of FIG. 5A.

Returning to decision block 518 of FIG. 5A, if one or more sensors monitored by the MLTM module 101 recorded thermal dissipation rates in response to the bin setting combination that were inconsistent with the last application of that bin setting combination, but other sensors reached their target temperature in the expected time, then the MLTM module may deduce that there have been changes to the health or performance specs of one or more of the thermal aggressors and the “no” branch is followed to block 520 of FIG. 5B. At block 520, the bin setting combinations associated with the thermal aggressors may be flagged in the thermal settings database 27 for reevaluation through an incremental learning process. As a result, updated and more optimal bin setting combinations associated with the flagged thermal aggressors may be identified for future application (notably, it is envisioned that in some embodiments the method 500, upon recognizing or “flagging” the bin setting combinations at block 520, may immediately enter the incremental iterative process described below relative to blocks 532 and 534 so that optimum settings may be identified, updated in TS database 27 and applied to the processing components). The Dynamic Mitigation Table 28 is updated at block 522, the settings are applied and the method 500 returns.

Returning to decision block 508, if no performance bin settings combinations have been previously learned in association with the thermal event of block 504, the “no” branch is followed to decision block 528 of FIG. 5C. At decision block 528, the method 500 determines whether existing bin setting combinations need incremental updating or default bin setting combinations (i.e., all minimum power levels indicated in the Dynamic Mitigation Table 28) need to be determined.

If default bin setting combinations need to be replaced with a first iteration of bin setting combinations for the thermal event, the method 500 follows the “no” branch to sub-routine 530 and a full iterative learning for the target temperature is conducted. If existing bin setting combinations have been flagged for incremental adjustment or updating, such as may have been the result of a determination at decision block 518 that the health or performance specs of one or more of the thermal aggressors have changed, the method 500 follows the “yes” branch and the sub-routine 532 conducts an incremental learning algorithm. Upon completion of either of sub-routines 530 and 532, the method 500 proceeds to block 534 and the Thermal Settings Database 27 is updated with the newly learned valid bin setting combinations. The method returns to block 510 of FIG. 5A.

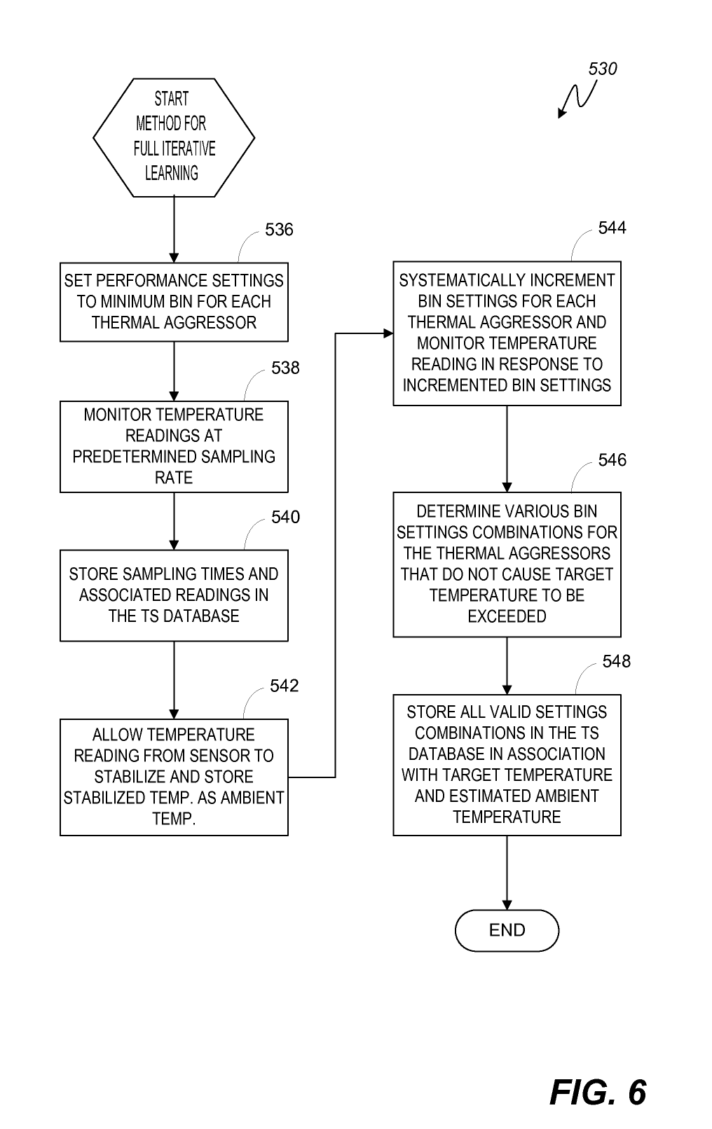

FIG. 6 is a logical flowchart illustrating a sub-method or subroutine 530 for an initial full iterative learning of the multi-correlative thermal dynamics between multiple thermal aggressors and multiple temperature sensors in association with a given target temperature. Beginning at block 536, the performance levels for each thermal aggressor are set to their minimum performance levels (as may have been indicated in a default table in the Dynamic Mitigation Table 28). At block 538, temperature readings from one or more thermal sensors are monitored and at block 540 a heat dissipation curve is created from the monitored temperature readings and stored in the TS database 27. When the temperature readings stabilize, at block 542 the ambient temperature to which the PCD is exposed is recorded. At block 544, incremental increases of the bin settings for the various thermal aggressors are applied in an effort to find valid combinations of bin settings across all thermal aggressors that result in thermal energy generation levels that will not cause the temperature threshold associated with the thermal event to be exceeded. As the bin setting combinations are identified at block 546, at block 548 the combinations are stored in association with the previously derived ambient temperature and the target operating temperature. Advantageously, the valid combinations of bin settings learned in this manner may be queried in the future for selection of a bin setting combination that best suits the given use case at the time.

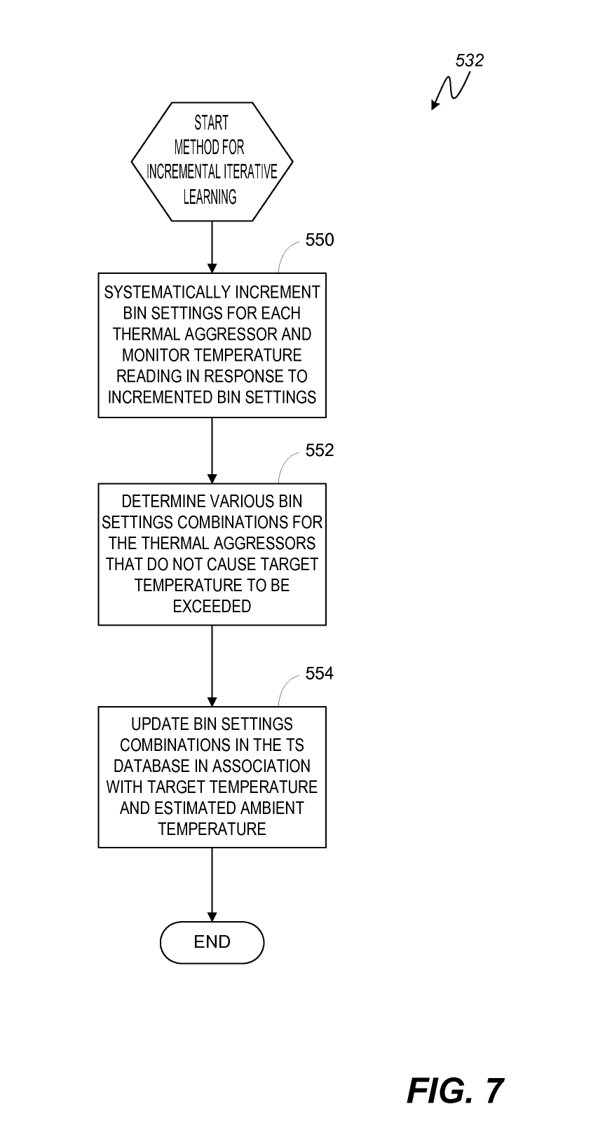

FIG. 7 is a logical flowchart illustrating a sub-method or subroutine 532 for an additional incremental iterative learning of the multi-correlative thermal dynamics between multiple thermal aggressors and multiple temperature sensors in association with a given target temperature. At block 550, bin settings for one or more flagged thermal aggressors are incremented and temperature readings from various sensors known to be affected by the flagged thermal aggressors are monitored. Notably, in the event that incremental learning has been flagged due to a determination that the performance specs of one or more aggressors has changed since the last iteration of learning, the method may only seek to learn new bin setting combinations that include newly defined bin settings. At block 552, existing bin setting combinations of those thermal aggressors are modified or new bin setting combinations are identified. At block 554, the Thermal Settings Database 27 is updated to include the new valid bin setting combinations.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, “subsequently” etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for multi-correlative learning thermal management in a portable computing device (“PCD”), the method comprising:
monitoring a plurality of temperature sensors in the PCD;
receiving an interrupt signal from one of the plurality of temperature sensors, wherein the interrupt signal indicates an alert that a target temperature threshold associated with the temperature sensor has been exceeded;
setting the performance level for each of a plurality of processing components to a minimum performance level;
sampling, at time based intervals, temperature signals from one or more of the plurality of temperature sensors, wherein sampling the temperature signals from a given temperature sensor at time based intervals generates data operable to be mapped as a heat dissipation curve associated with the given temperature sensor;
receiving a stabilized temperature signal from one or more of the plurality of temperature sensors, wherein the stabilized temperature signal is associated with an ambient environment temperature;
incrementing the performance levels of each of the plurality of processing components to learn performance level combinations for the plurality of processing components that generate thermal energy levels up to and within target temperature thresholds associated with each of the plurality of temperature sensors;
storing in a thermal settings database the learned performance level combinations in association with each of the plurality of temperature sensors, the ambient environment temperature, thermal energy levels and the heat dissipation curve associated with each of the plurality of temperature sensors;
selecting an optimum performance level combination from the learned performance level combinations and updating a dynamic mitigation table with the selected optimum performance level combination; and
applying the selected optimum performance level combination to the plurality of processing components, wherein applying the selected optimum performance level combination generates a thermal energy level that clears the first alert.

2. The method of claim 1, wherein the selected optimum performance level combination is selected based on an active performance level combination at the time of the alert.

3. The method of claim 1, further comprising:
receiving a second interrupt signal from the temperature sensor, wherein the second interrupt signal indicates a second alert that the target temperature threshold associated with the temperature sensor has been exceeded;
querying the dynamic mitigation table to identify the optimum performance level combination; and
applying the optimum performance level combination to the plurality of processing components, wherein applying the optimum performance level combination generates a thermal energy level that clears the second alert.

4. The method of claim 1, further comprising:
receiving a second interrupt signal from the temperature sensor, wherein the second interrupt signal indicates a second alert that the target temperature threshold associated with the temperature sensor has been exceeded;
querying the dynamic mitigation table to identify the optimum performance level combination;
applying the optimum performance level combination to the plurality of processing components, wherein applying the optimum performance level combination is expected to generate a thermal energy level that clears the second alert within an expected amount of time;
monitoring the temperature signal from the temperature sensor after application of the optimum performance level;
determining that the second alert is cleared in an actual amount of time that is shorter in duration than the expected amount of time;
calculating that the ambient environment temperature has decreased;
selecting a new optimum performance level combination based on the decreased ambient environment temperature;
updating the dynamic mitigation table to include the new optimum performance level combination; and
applying the new optimum performance level combination to the plurality of processing components.

5. The method of claim 1, further comprising:
receiving a second interrupt signal from the temperature sensor, wherein the second interrupt signal indicates a second alert that the target temperature threshold associated with the temperature sensor has been exceeded;
querying the dynamic mitigation table to identify the optimum performance level combination;
applying the optimum performance level combination to the plurality of processing components, wherein applying the optimum performance level combination is expected to generate a thermal energy level that clears the second alert within an expected amount of time;
monitoring the temperature signal from the temperature sensor after application of the optimum performance level;
determining that the second alert has not cleared within the expected amount of time;
calculating that the ambient environment temperature has increased;
selecting a new optimum performance level combination based on the increased ambient environment temperature;
updating the dynamic mitigation table to include the new optimum performance level combination; and
applying the new optimum performance level combination to the plurality of processing components.

6. The method of claim 1, further comprising:
receiving a second interrupt signal from the temperature sensor, wherein the second interrupt signal indicates a second alert that the target temperature threshold associated with the temperature sensor has been exceeded;
querying the dynamic mitigation table to identify the optimum performance level combination;
applying the optimum performance level combination to the plurality of processing components, wherein applying the optimum performance level combination is expected to generate a thermal energy level that clears the second alert within an expected amount of time;
monitoring the temperature signal from the temperature sensor after application of the optimum performance level;
determining that the second alert has not cleared within the expected amount of time;
determining that the performance capabilities of one or more of the plurality of processing components has changed; and
flagging in the thermal settings database that the learned performance level combinations require reevaluation.

7. The method of claim 6, further comprising:
updating the thermal settings database with the applied optimum performance level combination in association with a temperature that resulted from the application of the optimum performance level combination;
determining a new optimum performance level combination;
updating the dynamic mitigation table with the new optimum performance level combination; and
applying the new optimum performance level combination to the plurality of processing components.

8. The method of claim 1, further comprising:
receiving a second interrupt signal from the temperature sensor, wherein the second interrupt signal indicates an alert that a new target temperature threshold associated with the temperature sensor has been exceeded;
determining that performance level combinations that generate thermal energy levels up to and within the new target temperature threshold associated with the temperature sensor have not been previously learned;
incrementing the performance levels of each of the plurality of processing components to learn new performance level combinations for the plurality of processing components that generate a thermal energy level up to and within the new target temperature threshold associated with the temperature sensor as well as up to and within target temperature thresholds associated with each of the other plurality of temperature sensors;
storing in the thermal settings database the new learned performance level combinations in association with each of the plurality of temperature sensors and the ambient environment temperature;
selecting an optimum performance level combination from the new learned performance level combinations and updating the dynamic mitigation table with the selected new optimum performance level combination; and
applying the selected new optimum performance level combination to the plurality of processing components, wherein applying the selected new optimum performance level combination generates a thermal energy level that clears the second alert.

9. The method of claim 8, wherein the new optimum performance level combination is selected based on an active performance level combination at the time of the second alert.

10. The method of claim 1, wherein the plurality of processing components comprises a processing component selected from a group comprised of a graphical processing unit (“GPU”), a central processing unit (“CPU”) and a wireless modem.

11. A computer system for multi-correlative learning thermal management in a portable computing device (“PCD”), the system comprising:
a multi-correlative learning thermal management (“MLTM”) module, configured to:
monitor a plurality of temperature sensors in the PCD;
receive an interrupt signal from one of the plurality of temperature sensors, wherein the interrupt signal indicates an alert that a target temperature threshold associated with the temperature sensor has been exceeded;
set the performance level for each of a plurality of processing components to a minimum performance level;
sample, at time based intervals, temperature signals from one or more of the plurality of temperature sensors, wherein sampling the temperature signals from a given temperature sensor at time based intervals generates data operable to be mapped as a heat dissipation curve associated with the given temperature sensor;
receive a stabilized temperature signal from one or more of the plurality of temperature sensors, wherein the stabilized temperature signal is associated with an ambient environment temperature;
increment the performance levels of each of the plurality of processing components to learn performance level combinations for the plurality of processing components that generate thermal energy levels up to and within target temperature thresholds associated with each of the plurality of temperature sensors;
store in a thermal settings database the learned performance level combinations in association with each of the plurality of temperature sensors, the ambient environment temperature, thermal energy levels and the heat dissipation curve associated with each of the plurality of temperature sensors;
select an optimum performance level combination from the learned performance level combinations and updating a dynamic mitigation table with the selected optimum performance level combination; and
apply the selected optimum performance level combination to the plurality of processing components, wherein applying the selected optimum performance level combination generates a thermal energy level that clears the first alert.

12. The computer system of claim 11, wherein the selected optimum performance level combination is selected based on an active performance level combination at the time of the alert.

13. The computer system of claim 11, wherein the MLTM module is further configured to:
receive a second interrupt signal from the temperature sensor, wherein the second interrupt signal indicates a second alert that the target temperature threshold associated with the temperature sensor has been exceeded;
query the dynamic mitigation table to identify the optimum performance level combination; and
apply the optimum performance level combination to the plurality of processing components, wherein applying the optimum performance level combination generates a thermal energy level that clears the second alert.

14. The computer system of claim 11, wherein the MLTM module is further configured to:
receive a second interrupt signal from the temperature sensor, wherein the second interrupt signal indicates a second alert that the target temperature threshold associated with the temperature sensor has been exceeded;
query the dynamic mitigation table to identify the optimum performance level combination;
apply the optimum performance level combination to the plurality of processing components, wherein applying the optimum performance level combination is expected to generate a thermal energy level that clears the second alert within an expected amount of time;
monitor the temperature signal from the temperature sensor after application of the optimum performance level;
determine that the second alert is cleared in an actual amount of time that is shorter in duration than the expected amount of time;
calculate that the ambient environment temperature has decreased;
select a new optimum performance level combination based on the decreased ambient environment temperature;
update the dynamic mitigation table to include the new optimum performance level combination; and
apply the new optimum performance level combination to the plurality of processing components.

15. The computer system of claim 11, wherein the MLTM module is further configured to:
receive a second interrupt signal from the temperature sensor, wherein the second interrupt signal indicates a second alert that the target temperature threshold associated with the temperature sensor has been exceeded;
query the dynamic mitigation table to identify the optimum performance level combination;
apply the optimum performance level combination to the plurality of processing components, wherein applying the optimum performance level combination is expected to generate a thermal energy level that clears the second alert within an expected amount of time;
monitor the temperature signal from the temperature sensor after application of the optimum performance level;
determine that the second alert has not cleared within the expected amount of time;
calculate that the ambient environment temperature has increased;
select a new optimum performance level combination based on the increased ambient environment temperature;
update the dynamic mitigation table to include the new optimum performance level combination; and
apply the new optimum performance level combination to the plurality of processing components.

16. The computer system of claim 11, wherein the MLTM module is further configured to:
receive a second interrupt signal from the temperature sensor, wherein the second interrupt signal indicates a second alert that the target temperature threshold associated with the temperature sensor has been exceeded;
query the dynamic mitigation table to identify the optimum performance level combination;
apply the optimum performance level combination to the plurality of processing components, wherein applying the optimum performance level combination is expected to generate a thermal energy level that clears the second alert within an expected amount of time;
monitor the temperature signal from the temperature sensor after application of the optimum performance level;
determine that the second alert has not cleared within the expected amount of time;
determine that the performance capabilities of one or more of the plurality of processing components has changed; and
flag in the thermal settings database that the learned performance level combinations require reevaluation.

17. The method of claim 16, wherein the MLTM module is further configured to:
update the thermal settings database with the applied optimum performance level combination in association with a temperature that resulted from the application of the optimum performance level combination;
determine a new optimum performance level combination;
update the dynamic mitigation table with the new optimum performance level combination; and
apply the new optimum performance level combination to the plurality of processing components.

18. The computer system of claim 11, wherein the MLTM module is further configured to:
receive a second interrupt signal from the temperature sensor, wherein the second interrupt signal indicates an alert that a new target temperature threshold associated with the temperature sensor has been exceeded;
determine that performance level combinations that generate thermal energy levels up to and within the new target temperature threshold associated with the temperature sensor have not been previously learned;
increment the performance levels of each of the plurality of processing components to learn new performance level combinations for the plurality of processing components that generate a thermal energy level up to and within the new target temperature threshold associated with the temperature sensor as well as up to and within target temperature thresholds associated with each of the other plurality of temperature sensors;
store in the thermal settings database the new learned performance level combinations in association with each of the plurality of temperature sensors and the ambient environment temperature;
select an optimum performance level combination from the new learned performance level combinations and updating the dynamic mitigation table with the selected new optimum performance level combination; and
apply the selected new optimum performance level combination to the plurality of processing components, wherein applying the selected new optimum performance level combination generates a thermal energy level that clears the second alert.

19. The computer system of claim 18, wherein the new optimum performance level combination is selected based on an active performance level combination at the time of the second alert.

20. The computer system of claim 11, wherein the plurality of processing components comprises a processing component selected from a group comprised of a graphical processing unit (“GPU”), a central processing unit (“CPU”) and a wireless modem.

21. A computer system for multi-correlative learning thermal management in a portable computing device (“PCD”), the system comprising:
means for monitoring a plurality of temperature sensors in the PCD;
means for receiving an interrupt signal from one of the plurality of temperature sensors, wherein the interrupt signal indicates an alert that a target temperature threshold associated with the temperature sensor has been exceeded;
means for setting the performance level for each of a plurality of processing components to a minimum performance level;
means for sampling, at time based intervals, temperature signals from one or more of the plurality of temperature sensors, wherein sampling the temperature signals from a given temperature sensor at time based intervals generates data operable to be mapped as a heat dissipation curve associated with the given temperature sensor;
means for receiving a stabilized temperature signal from one or more of the plurality of temperature sensors, wherein the stabilized temperature signal is associated with an ambient environment temperature;
means for incrementing the performance levels of each of the plurality of processing components to learn performance level combinations for the plurality of processing components that generate thermal energy levels up to and within target temperature thresholds associated with each of the plurality of temperature sensors;
means for storing in a thermal settings database the learned performance level combinations in association with each of the plurality of temperature sensors, the ambient environment temperature, thermal energy levels and the heat dissipation curve associated with each of the plurality of temperature sensors;
means for selecting an optimum performance level combination from the learned performance level combinations and updating a dynamic mitigation table with the selected optimum performance level combination; and
means for applying the selected optimum performance level combination to the plurality of processing components, wherein applying the selected optimum performance level combination generates a thermal energy level that clears the first alert.

22. The computer system of claim 21, wherein the selected optimum performance level combination is selected based on an active performance level combination at the time of the alert.

23. The computer system of claim 21, further comprising:
means for receiving a second interrupt signal from the temperature sensor, wherein the second interrupt signal indicates a second alert that the target temperature threshold associated with the temperature sensor has been exceeded;
means for querying the dynamic mitigation table to identify the optimum performance level combination; and
means for applying the optimum performance level combination to the plurality of processing components, wherein applying the optimum performance level combination generates a thermal energy level that clears the second alert.

24. The computer system of claim 21, further comprising:
means for receiving a second interrupt signal from the temperature sensor, wherein the second interrupt signal indicates a second alert that the target temperature threshold associated with the temperature sensor has been exceeded;
means for querying the dynamic mitigation table to identify the optimum performance level combination;
means for applying the optimum performance level combination to the plurality of processing components, wherein applying the optimum performance level combination is expected to generate a thermal energy level that clears the second alert within an expected amount of time;
means for monitoring the temperature signal from the temperature sensor after application of the optimum performance level;
means for determining that the second alert is cleared in an actual amount of time that is shorter in duration than the expected amount of time;
means for calculating that the ambient environment temperature has decreased;
means for selecting a new optimum performance level combination based on the decreased ambient environment temperature;
means for updating the dynamic mitigation table to include the new optimum performance level combination; and
means for applying the new optimum performance level combination to the plurality of processing components.

25. The computer system of claim 21, further comprising:
means for receiving a second interrupt signal from the temperature sensor, wherein the second interrupt signal indicates a second alert that the target temperature threshold associated with the temperature sensor has been exceeded;
means for querying the dynamic mitigation table to identify the optimum performance level combination;
means for applying the optimum performance level combination to the plurality of processing components, wherein applying the optimum performance level combination is expected to generate a thermal energy level that clears the second alert within an expected amount of time;
means for monitoring the temperature signal from the temperature sensor after application of the optimum performance level;
means for determining that the second alert has not cleared within the expected amount of time;
means for calculating that the ambient environment temperature has increased;
means for selecting a new optimum performance level combination based on the increased ambient environment temperature;
means for updating the dynamic mitigation table to include the new optimum performance level combination; and
means for applying the new optimum performance level combination to the plurality of processing components.

26. The computer system of claim 21, further comprising:
means for receiving a second interrupt signal from the temperature sensor, wherein the second interrupt signal indicates a second alert that the target temperature threshold associated with the temperature sensor has been exceeded;
means for querying the dynamic mitigation table to identify the optimum performance level combination;
means for applying the optimum performance level combination to the plurality of processing components, wherein applying the optimum performance level combination is expected to generate a thermal energy level that clears the second alert within an expected amount of time;
means for monitoring the temperature signal from the temperature sensor after application of the optimum performance level;
means for determining that the second alert has not cleared within the expected amount of time;
means for determining that the performance capabilities of one or more of the plurality of processing components has changed; and
means for flagging in the thermal settings database that the learned performance level combinations require reevaluation.

27. The computer system of claim 26, further comprising:
means for updating the thermal settings database with the applied optimum performance level combination in association with a temperature that resulted from the application of the optimum performance level combination;
means for determining a new optimum performance level combination;
means for updating the dynamic mitigation table with the new optimum performance level combination; and
means for applying the new optimum performance level combination to the plurality of processing components.

28. The computer system of claim 21, further comprising:
means for receiving a second interrupt signal from the temperature sensor, wherein the second interrupt signal indicates an alert that a new target temperature threshold associated with the temperature sensor has been exceeded;
means for determining that performance level combinations that generate thermal energy levels up to and within the new target temperature threshold associated with the temperature sensor have not been previously learned;
means for incrementing the performance levels of each of the plurality of processing components to learn new performance level combinations for the plurality of processing components that generate a thermal energy level up to and within the new target temperature threshold associated with the temperature sensor as well as up to and within target temperature thresholds associated with each of the other plurality of temperature sensors;
means for storing in the thermal settings database the new learned performance level combinations in association with each of the plurality of temperature sensors and the ambient environment temperature;
means for selecting an optimum performance level combination from the new learned performance level combinations and updating the dynamic mitigation table with the selected new optimum performance level combination; and
means for applying the selected new optimum performance level combination to the plurality of processing components, wherein applying the selected new optimum performance level combination generates a thermal energy level that clears the second alert.

29. The computer system of claim 28, wherein the new optimum performance level combination is selected based on an active performance level combination at the time of the second alert.

30. The computer system of claim 21, wherein the plurality of processing components comprises a processing component selected from a group comprised of a graphical processing unit (“GPU”), a central processing unit (“CPU”) and a wireless modem.

31. A computer program product comprising a computer usable medium having a computer readable program code embodied therein, said computer readable program code adapted to be executed to implement a method for multi-correlative learning thermal management in a portable computing device (“PCD”), said method comprising:
monitoring a plurality of temperature sensors in the PCD;
receiving an interrupt signal from one of the plurality of temperature sensors, wherein the interrupt signal indicates an alert that a target temperature threshold associated with the temperature sensor has been exceeded;
setting the performance level for each of a plurality of processing components to a minimum performance level;
sampling, at time based intervals, temperature signals from one or more of the plurality of temperature sensors, wherein sampling the temperature signals from a given temperature sensor at time based intervals generates data operable to be mapped as a heat dissipation curve associated with the given temperature sensor;
receiving a stabilized temperature signal from one or more of the plurality of temperature sensors, wherein the stabilized temperature signal is associated with an ambient environment temperature;
incrementing the performance levels of each of the plurality of processing components to learn performance level combinations for the plurality of processing components that generate thermal energy levels up to and within target temperature thresholds associated with each of the plurality of temperature sensors;
storing in a thermal settings database the learned performance level combinations in association with each of the plurality of temperature sensors, the ambient environment temperature, thermal energy levels and the heat dissipation curve associated with each of the plurality of temperature sensors;
selecting an optimum performance level combination from the learned performance level combinations and updating a dynamic mitigation table with the selected optimum performance level combination [FIG. 5A, block 510]; and
applying the selected optimum performance level combination to the plurality of processing components, wherein applying the selected optimum performance level combination generates a thermal energy level that clears the first alert.

32. The computer program product of claim 31, wherein the selected optimum performance level combination is selected based on an active performance level combination at the time of the alert.

33. The computer program product of claim 31, further comprising:
receiving a second interrupt signal from the temperature sensor, wherein the second interrupt signal indicates a second alert that the target temperature threshold associated with the temperature sensor has been exceeded;
querying the dynamic mitigation table to identify the optimum performance level combination; and
applying the optimum performance level combination to the plurality of processing components, wherein applying the optimum performance level combination generates a thermal energy level that clears the second alert.

34. The computer program product of claim 31, further comprising:
receiving a second interrupt signal from the temperature sensor, wherein the second interrupt signal indicates a second alert that the target temperature threshold associated with the temperature sensor has been exceeded;
querying the dynamic mitigation table to identify the optimum performance level combination;
applying the optimum performance level combination to the plurality of processing components, wherein applying the optimum performance level combination is expected to generate a thermal energy level that clears the second alert within an expected amount of time;
monitoring the temperature signal from the temperature sensor after application of the optimum performance level;
determining that the second alert is cleared in an actual amount of time that is shorter in duration than the expected amount of time;
calculating that the ambient environment temperature has decreased;
selecting a new optimum performance level combination based on the decreased ambient environment temperature;
updating the dynamic mitigation table to include the new optimum performance level combination; and
applying the new optimum performance level combination to the plurality of processing components.

35. The computer program product of claim 31, further comprising:
receiving a second interrupt signal from the temperature sensor, wherein the second interrupt signal indicates a second alert that the target temperature threshold associated with the temperature sensor has been exceeded;
querying the dynamic mitigation table to identify the optimum performance level combination;
applying the optimum performance level combination to the plurality of processing components, wherein applying the optimum performance level combination is expected to generate a thermal energy level that clears the second alert within an expected amount of time;
monitoring the temperature signal from the temperature sensor after application of the optimum performance level;
determining that the second alert has not cleared within the expected amount of time;
calculating that the ambient environment temperature has increased;
selecting a new optimum performance level combination based on the increased ambient environment temperature;
updating the dynamic mitigation table to include the new optimum performance level combination; and
applying the new optimum performance level combination to the plurality of processing components.

36. The computer program product of claim 31, further comprising:
receiving a second interrupt signal from the temperature sensor, wherein the second interrupt signal indicates a second alert that the target temperature threshold associated with the temperature sensor has been exceeded;
querying the dynamic mitigation table to identify the optimum performance level combination;
applying the optimum performance level combination to the plurality of processing components, wherein applying the optimum performance level combination is expected to generate a thermal energy level that clears the second alert within an expected amount of time;
monitoring the temperature signal from the temperature sensor after application of the optimum performance level;
determining that the second alert has not cleared within the expected amount of time;
determining that the performance capabilities of one or more of the plurality of processing components has changed; and
flagging in the thermal settings database that the learned performance level combinations require reevaluation.

37. The computer program product of claim 36, further comprising:
updating the thermal settings database with the applied optimum performance level combination in association with a temperature that resulted from the application of the optimum performance level combination;
determining a new optimum performance level combination;
updating the dynamic mitigation table with the new optimum performance level combination; and
applying the new optimum performance level combination to the plurality of processing components.

38. The computer program product of claim 31, further comprising:
receiving a second interrupt signal from the temperature sensor, wherein the second interrupt signal indicates an alert that a new target temperature threshold associated with the temperature sensor has been exceeded;
determining that performance level combinations that generate thermal energy levels up to and within the new target temperature threshold associated with the temperature sensor have not been previously learned;
incrementing the performance levels of each of the plurality of processing components to learn new performance level combinations for the plurality of processing components that generate a thermal energy level up to and within the new target temperature threshold associated with the temperature sensor as well as up to and within target temperature thresholds associated with each of the other plurality of temperature sensors;
storing in the thermal settings database the new learned performance level combinations in association with each of the plurality of temperature sensors and the ambient environment temperature;
selecting an optimum performance level combination from the new learned performance level combinations and updating the dynamic mitigation table with the selected new optimum performance level combination; and
applying the selected new optimum performance level combination to the plurality of processing components, wherein applying the selected new optimum performance level combination generates a thermal energy level that clears the second alert.

39. The computer program product of claim 38, wherein the new optimum performance level combination is selected based on an active performance level combination at the time of the second alert.

40. The computer program product of claim 31, wherein the plurality of processing components comprises a processing component selected from a group comprised of a graphical processing unit (“GPU”), a central processing unit (“CPU”) and a wireless modem.
